(19) United States
(12) Patent Application Publication
(10) Pub. No.: US 2006/0206389 A1
(43) Pub. Date: Sep. 14, 2006

(54) Method and system for providing medical device maintenance information to a service technician's mobile device

(76) Inventors: Frank Elssner, (US); Detlev Albrecht, (US); Thomas Burkart, (US)

Correspondence Address: BRINKS HOFER GILSON & LIONE, P.O. BOX 10395, CHICAGO, IL, 60610, US

(21) Appl. No.: 11/080,841

(22) Filed: Mar. 14, 2005

(51) Int. Cl. G06Q 30/00

(52) U.S. Cl. 705/26

(57) ABSTRACT

A method and system for providing medical device maintenance information to a service technician's mobile device are provided. In one embodiment, an order for a service technician to perform maintenance on a medical device is generated, and the appropriate maintenance protocol is automatically selected based on data from the order. The order and the maintenance protocol are then transmitted to the service technician's wireless communication device.

### Background

Service technicians are often required to perform maintenance on medical devices. In practice, an order is provided to a service technician informing him of the customer's location, type of medical device, and required maintenance. The service technician then determines and obtains the appropriate maintenance protocol required for the order by downloading the maintenance protocol from an intranet site, accessing the maintenance protocol from a CD, or looking-up the maintenance protocol in a product book. The maintenance protocol contains several fields that the service technician fills out with the customer and service engineer data present in the order. The maintenance protocol also contains checkboxes that the service technician checks off as he is conducting the maintenance. At the end of the maintenance, the service technician prints a report that is then filed in the system book for the medical device or given to the customer.

There are several disadvantages to this current approach to performing maintenance. First, a service technician may find it tedious to spend time finding the appropriate maintenance protocol and completing administrative information in the protocol. Also, if maintenance is interrupted for any reason, it can be very difficult to reconstruct the work that had been performed up to the interruption, and the service technician who completes the work may not be able to use the partially-completed maintenance protocol. Also, the current approach does not provide a history record of the medical device over its product life cycle.

### SUMMARY

The present invention is defined by the following claims, and nothing in this section should be taken as a limitation on those claims.

By way of introduction, the below embodiments describe a method and system for providing medical device maintenance information to a service technician's mobile device. In one embodiment, an order for a service technician to perform maintenance on a medical device is generated, and the appropriate maintenance protocol is automatically selected based on data from the order. The order and the maintenance protocol are then transmitted to the service technician's wireless communication device. Other embodiments are provided, and each of the embodiments described herein can be used alone or in combination with one another.

The embodiments will now be described with reference to the attached drawings.

### BRIEF DESCRIPTION OF THE DRAWINGS

FIG. 1 is a block diagram of a system of an embodiment.

FIG. 2 is a flowchart of a method of an embodiment.

FIG. 3 is an illustration of an embodiment in which a job order is displayed on a service technician's wireless communication device.

FIG. 4 is an illustration of an embodiment in which a maintenance protocol with automatically-completed fields is displayed on a service technician's wireless communication device.

FIG. 5 is an illustration of a maintenance protocol displayed on a service technician's wireless communication device of an embodiment.

FIG. 6 is an illustration of a signature page of a maintenance protocol displayed on a service technician's wireless communication device of an embodiment.

### DETAILED DESCRIPTION OF THE PRESENTLY PREFERRED EMBODIMENTS

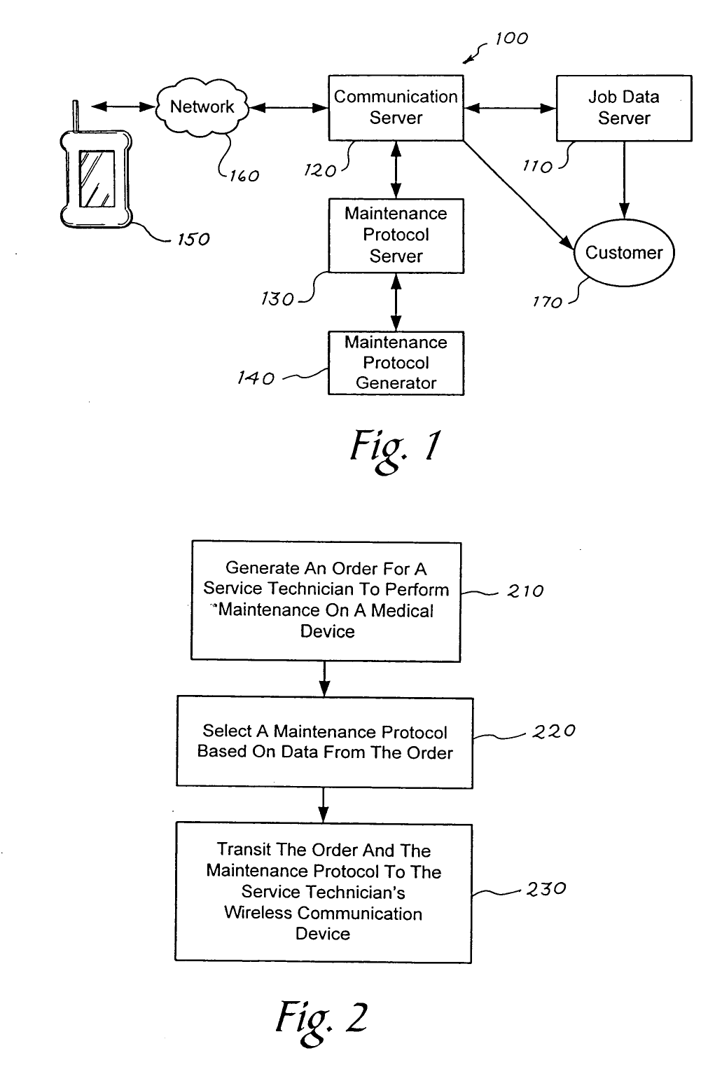

Turning now to the drawings, FIG. 1 is an illustration of a system 100 for remote servicing of a medical device using a wireless front-end mobile device, such as a PDA. As shown in FIG. 1, this system 100 comprises a job data server 110, a communication server 120, a maintenance protocol server 130, a maintenance protocol generator 140, and a wireless communication device 150 that communicates with the communication server 120 via a network 160 (e.g., telephone, cellular, computer, etc.). The term “wireless communication device” (or “mobile device”) refers to any mobile electronic device that can receive and/or transmit data via a wireless connection, such as via radio, cellular, or infrared transmissions. A wireless communication device can also communicate via a wired connection, such as when the device is placed in a cradle that is connected to a computer via a cable. Examples of a wireless communication device include, but are not limited to, a personal digital assistant (PDA), a laptop computer, and a cell phone. Preferably, the job data server 110 is a SAP server that communicates with the communication server 120 using RFC. Also, the communication server 120 and the wireless communication device 150 preferably communicate through the network 160 using SMS messages. It should be understood that any appropriate hardware (analog or digital) and/or software can be used to implement this system 100. It is presently preferred that the wireless communication device 150 use a Windows Pocket PC, CE, or XP operating system.

In this system 100, the wireless communication device 150 is used by a service technician. A “service technician” is any person who performs maintenance on a medical device. Often, but not necessarily, a service technician is employed by the manufacturer of the medical device or one of its affiliates. The term “service technician” will be used interchangeably herein with the term “customer service engineer (CSE).” “Maintenance on a medical device” refers to any operation that a service technician performs on a medical device. Examples of maintenance can include, but are not limited to, preventative maintenance, periodical preventative maintenance (e.g., of operating values and functions), software maintenance, hardware maintenance, servicing, installation, updating, safety inspection (e.g., image and/or system quality checks), and electrical and/or mechanical safety checks.

The maintenance protocol server 130 stores maintenance protocols to be used by a service technician in performing maintenance of a medical device. As used herein, the term “maintenance protocol” (or “maintenance report”) refers to either the maintenance protocol itself or the maintenance protocol together with maintenance instructions. A maintenance protocol can contain a general description, place holders for administrative data, as well as tables for tools and check point lists. Maintenance tasks are entered in the check points lists, for example, as a drop down menu with ok/not ok/n.a. choices. The protocol is preferable signed by the service technician to confirm that the maintenance has been carried out. Maintenance instructions contain detailed written explanations and diagrams that describe the tools, safety instructions, and work steps needed for the performance of the maintenance.

The maintenance protocols stored on the maintenance protocol server 130 are generated by a maintenance protocol generator 140 (also known as a document management system (or “DMS”)). Maintenance protocols are identified by document identifiers (or “DocIDs”). When a new maintenance protocol is released, it is transferred to the maintenance protocol server 130, and its DocID is sent to the communication server 120, which places it into an assignment table. The assignment table enables fast searching, locating, and selection of a DocID by the communication server 120. After its release to publication, a new maintenance protocol can also be sent to an archive (e.g., in PDF form). In one implementation, there are several maintenance servers (one for each country), and each maintenance server stores the maintenance protocols appropriate for its country. In this way, a maintenance server can be considered to be a “country server.”

Referring back to the drawings, FIG. 2 is a flowchart of a method for providing medical device maintenance information to a service technician. While this method will be illustrated in conjunction with the system 100 shown in FIG. 1, it is important to note that other components and configurations can be used and that the components and configurations shown in FIG. 1 should not be read into the method claims below. As shown in FIG. 2, an order for a service technician to perform maintenance on a medical device is generated (act 210). This act can be triggered by the service technician requesting a job order (or “notification data package (NDP)”) through his wireless communication device 150. The request is communicated through the network 160 and communication server 120 to the job data server 110. Maintenance tasks are planned in country service organizations in accordance with existing contracts, and the job data server 110 contains information about the maintenance tasks and information about customers and their medical devices. In response to the request, the job data server 110 sends the relevant order (which is also referred to herein as job data, job order, maintenance order, or order data) to the communication server 120. The communication server 120 extracts the relevant data to generate an order that will be transmitted and displayed on the service technician's wireless communication device 150.

Next, the communication server 120 automatically selects a maintenance protocol based on data from the order (act 220). In this embodiment, the job data contains a code (referred to herein as a “material number” or “MatNo”), and the communication server 120 consults its assignment table to finds the DocID corresponding to the MatNo in the job order and requests the maintenance protocol identified by the DocID from the maintenance protocol server 130. (Other mechanisms to find the appropriate maintenance protocol can be used. For example, instead of using the MatNo, the communication server 120 can identify the customer from the job order and, based on that identification, retrieve the protocol of the most-recently performed maintenance order.) The maintenance protocol server 130 then sends the requested maintenance protocol to the communication server 120, which converts it (e.g., using a mapping table) to a format suitable for display on the wireless communication device 150 (e.g., XML). For example, the maintenance protocol sent to the wireless communication device 150 can be a “trimmed down” version of the maintenance protocol stored in the maintenance protocol server 130, containing only the information relevant for processing on the wireless communication device 150. In this way, the maintenance job can be performed on the wireless communication device 150 without processing the full maintenance protocol.

If the maintenance protocol is not available or is not in the service technician's language (e.g., German instead of English), the communication server 120 instructs the service technician to generate the protocol using some other mechanism (e.g., “No electronic maintenance protocol available on server. Take the maintenance protocol CDs with you.”). Also, there can be more than one maintenance protocol for a particular MatNo. In such a situation, several maintenance protocols would-be sent to the communication server 120 instead of one, as in the above example.

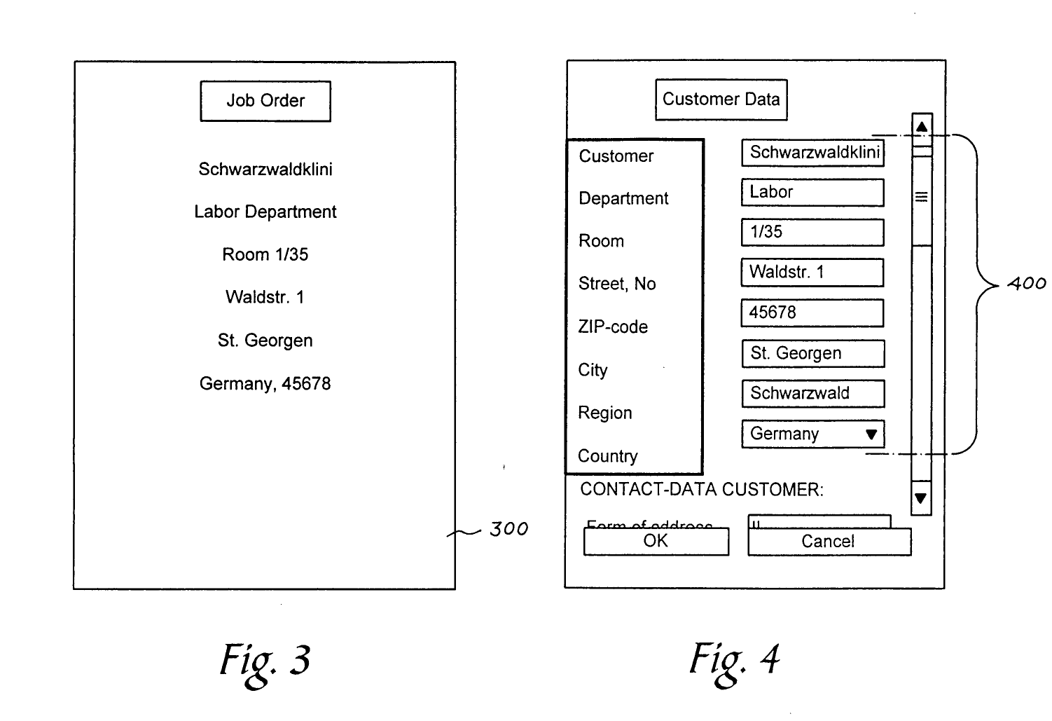

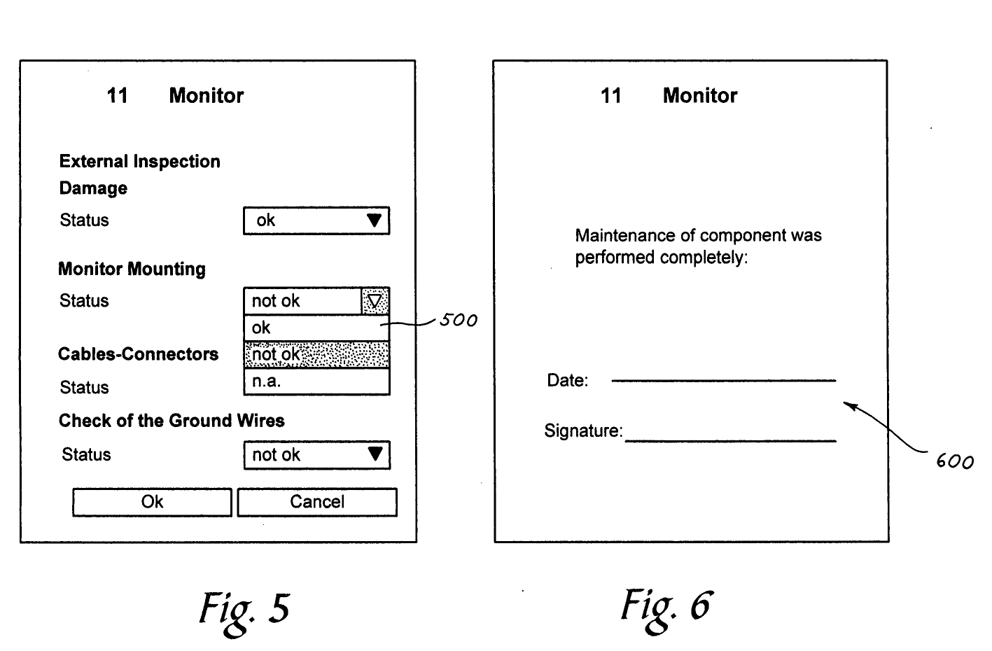

The order and the maintenance protocol are then transmitted to the service technician's wireless communication device 150 (act 230). FIG. 3 is an illustration of a job order 300 displayed on the wireless communication device 150, and FIG. 4-6 are illustrations of pages of a maintenance protocol displayed on the wireless communication device 150. The job order 300 contains the customer's name and location, and this data is automatically completed in the fields 400 of the page of the maintenance protocol shown in FIG. 4. The page of the maintenance protocol in FIG. 5 shows the various tasks that the service technician needs to perform during maintenance (e.g., external inspection damage, monitor mounting, cables/connectors, and check of ground wires), and a drop-down menu 500 is presented allowing the service technician to select “ok,” “not ok,” or “n.a.” The page of the maintenance protocol in FIG. 6 shows a signature block 600 that is required to complete this specific section (or “component”) of the maintenance protocol.

It should be noted that the order and the maintenance protocol can be transmitted together (i.e., transmitting both the order and the maintenance protocol in a single transmission) or separately (i.e., first transmitting the order and then transmitting the maintenance protocol). Irrespective of whether the order is transmitted together with or separately from the maintenance protocol, this method provides a time savings advantage over the current approach of performing maintenance. Because the maintenance protocol is automatically transmitted to the service provider's wireless communication device 150, the service technician does not need to waste time searching online for the maintenance protocol appropriate for the job order. This greatly reduces the service technician's administrative tasks before going on-site, while ensuring that the service technician has the most up-to-date maintenance protocol.

As another time savings mechanism, the communication server 120 can automatically complete at least some of the fields in the maintenance protocol with data from the order before transmitting the maintenance protocol to the service technician's wireless communication device 150. This minimizes the administrative tasks that need to be performed by the service technician, allowing him to more quickly turn to performing maintenance. Additionally, displaying only the individual test items that need to be completed results in a cleaner, less cluttered workflow on the service technician's wireless communication device 150. Overall, this accelerates and simplifies the service technician's workflow, reducing the frequency of errors. Examples of some of the fields that can be automatically completed include, but are not limited to, notification number, action notification number, PDA phone number, disp. number from the actions, order transaction number, order type, name of customer, department, room, street, place, postal code, customer telephone number, customer fax number, system remote number, customer order number, dispatcher name, clarification status, clarification text, repair limit, manufacturer proprietary system ID number, equipment number, equipment material number, equipment serial number, division, equipment name, type of contract, measurement point, regional office, sales region, name of service technician carrying out the work, uptime service center (USC) telephone number, order type, message number, transaction number, system status, system name, main equipment serial number, software version, number of maintenance contract, type of contact, IVK structure (components name and serial number), and M protocol signature.

At the end of maintenance, the service technician signs the maintenance protocol on the wireless communication device 150 and transmits the completed maintenance protocol to the communication server 120. The communication server 120 updates the job data server 100 to indicate that the maintenance is complete and converts the trimmed-down version of the completed maintenance protocol to a full version. The full version is then sent to an email address provided for in the maintenance protocol. The full version can be stored in the job data server 110 or another server (e.g., the maintenance protocol server 130). Storing the completed (or partially-completed) maintenance protocol in a central location provides easier access to the stored maintenance protocol and improved archiving capabilities. This also provides the ability to automatically generate service reports, fax documents, and emails, as well as to display stored maintenance protocols on the Internet.

The full version can also be sent (e.g., emailed or faxed) to the customer and stored on a server (e.g., the maintenance protocol server 130). Alternatively, the customer can receive a one-page test certificate. The customer's preference can be selected by the service technician on his wireless communication device 150. The customer can also receive a link and password to an Internet site to allow the customer to see or print-out further details of the maintenance protocol. Any or all of these possibilities are encompassed in the phrase “providing the completed maintenance protocol to the customer,” as used in the claims.

If the service technician fails to complete the maintenance protocol, a partially-completed maintenance protocol can be transmitted from the service technician's wireless communication device 150 to the communication server 120 for storage and later completion (the communication server 120 would also provide job status to the job data server 110). The partially-completed maintenance protocol can be temporarily stored in any suitable location (e.g., the communication server 120 or the maintenance protocol server 130) until requested by the same or another service technician. Upon such a request, the partially-completed maintenance protocol would be sent to that service technician's wireless communication device (e.g., in response to a request to manually load the partially-completed maintenance protocol onto his wireless communication device; it is also possible for a service technician to manually load a new maintenance protocol). It is preferred that each section (i.e., chapter or “component”) of the maintenance protocol be signed and dated. This explicit conclusion of individual components of the maintenance protocol ensures the ability to subsequently track which components were processed when and by whom. Also, this requirement ensures that interruptions can only occur after processing a complete component. In this way, a service technician performing the follow-up work will be able to see which test items have been completed and then continue maintenance at the appropriate point in the process.

The above-described functionality can be implemented using any appropriate hardware and/or software component. In one embodiment, the functionality is implemented on an article of manufacture comprising a computer-readable storage medium and computer-readable data stored therein. Examples of the article include, but are not limited to, an electronic storage medium having electronic data, a magnetic storage medium having magnetic data, and an optical storage medium having optical data. Also, as used herein, the phrase “a server operative to” perform a function means that a single server can be used to perform the function, or two or more servers can be used to perform the function.

Lastly, it should be noted that the term “medical device” is intended to broadly cover any medical device, including, but not limited to, medical imaging devices, such as ultrasound imaging systems and those that use any of the following imaging modalities: computed tomography (CT), magnetic resonance imaging (MRI), computed radiography, magnetic resonance, angioscopy, color flow Doppler, cystoscopy, diaphanography, echocardiography, fluoresosin angiography, laparoscopy, magnetic resonance angiography, positron emission tomography, single-photon emission computed tomography, x-ray angiography, computed tomography, nuclear medicine, biomagnetic imaging, culposcopy, duplex Doppler, digital microscopy, endoscopy, fundoscopy, laser surface scan, magnetic resonance spectroscopy, radiographic imaging, thermography, and radio fluroscopy.

It is intended that the foregoing detailed description be understood as an illustration of selected forms that the invention can take and not as a definition of the invention. It is only the following claims, including all equivalents, that are intended to define the scope of this invention.

What is claimed is:

1. A method for providing medical device maintenance information to a service technician, the method comprising:
(a) generating an order for a service technician to perform maintenance on a medical device;
(b) automatically selecting a maintenance protocol based on data from the order; and
(c) transmitting the order and the maintenance protocol to the service technician's wireless communication device.

2. The method of claim 1, wherein the maintenance protocol comprises a plurality of fields, and wherein the method further comprises automatically completing at least some of the plurality of fields with data from the order.

3. The method of claim 1 further comprising converting the maintenance protocol selected in (b) to a version suitable for the service technician's wireless communication device, and wherein the maintenance protocol transmitted in (c) is the version suitable for the service technician's wireless communication device.

4. The method of claim 1 further comprising:
(d) transmitting a completed maintenance protocol from the service technician's wireless communication device to a server; and
(e) storing the completed maintenance protocol.

5. The method of claim 4 further comprising converting the completed maintenance protocol from a version suitable for the service technician's wireless communication device to a different version.

6. The method of claim 4, wherein the medical device is associated with a customer, and wherein the method further comprises:
(f) providing the completed maintenance protocol to the customer.

7. The method of claim 1 further comprising:
(d) transmitting a partially-completed maintenance protocol from the service technician's wireless communication device to a server;
(e) storing the partially-completed maintenance protocol; and
(f) transmitting the partially-completed maintenance protocol to a same or different service technician's wireless communication device for completion.

8. The method of claim 1, wherein the wireless communication device comprises a personal digital assistant (PDA).

9. The method of claim 1, wherein the wireless communication device comprises a laptop computer.

10. The method of claim 1, wherein the wireless communication device comprises a cell phone.

11. A system for providing medical device maintenance information to a service technician, the system comprising:
a wireless communication device; and
a server operative to:
generate an order for a service technician to perform maintenance on a medical device;
automatically select a maintenance protocol based on data from the order; and
transmit the order and the maintenance protocol to the wireless communication device.

12. The system of claim 11, wherein the maintenance protocol comprises a plurality of fields, and wherein the server is further operative to automatically complete at least some of the plurality of fields with data from the order.

13. The system of claim 11, wherein the server is further operative to convert the selected maintenance protocol to a version suitable for the wireless communication device, and wherein the transmitted maintenance protocol is the version suitable for the wireless communication device.

14. The system of claim 11, wherein the server is further operative to store a completed maintenance protocol transmitted from the wireless communication device.

15. The system of claim 14, wherein the server is further operative to convert the completed maintenance protocol from a version suitable for the wireless communication device to a different version.

16. The system of claim 14, wherein the medical device is associated with a customer, and wherein the server is further operative to provide the completed maintenance protocol to the customer.

17. The system of claim 11, wherein the server is further operative to store a partially-completed maintenance protocol transmitted from the wireless communication device and transmit the partially-completed maintenance protocol to the same or different wireless communication device for completion.

18. The system of claim 11, wherein the wireless communication device comprises a personal digital assistant (PDA).

19. The system of claim 11, wherein the wireless communication device comprises a laptop computer.

20. The system of claim 11, wherein the wireless communication device comprises a cell phone.
